(19) United States
(12) Patent Application Publication
(10) Pub. No.: US 2020/0071043 A1
(43) Pub. Date: Mar. 5, 2020

(54) SYSTEMS AND METHODS FOR AN OBJECT WITH A BONDED ADHESIVE STRIP

(71) Applicant: NITE IZE, INC., Boulder, CO (US)

(72) Inventor: Daniel J. Martinson, Medina, MN (US)

(21) Appl. No.: 16/676,231

(22) Filed: Nov. 6, 2019

Related U.S. Application Data
(62) Division of application No. 14/759,388, filed on Jul. 6, 2015.
(60) Provisional application No. 61/749,810, filed on Jan. 7, 2013.

(51) Int. Cl. B65D 63/18; B29C 70/78; B29C 70/76; B32B 7/06; B32B 27/32; B65D 63/04; B65D 63/00

(52) U.S. Cl. CPC B65D 63/18; B29C 70/78; B29C 70/76; B29K 2101/12; B32B 27/32; B65D 63/04; B65D 63/00; B32B 7/06

(57) ABSTRACT

A method includes placing a first end of a twist tie in a mold, placing a piece of adhesive material in the mold, and extruding a material into the mold to bond the extruded material, the piece of adhesive material, and the first end of the twist tie together. The piece of adhesive material may include an adhesive surface covered with a removable cover on a first side and a non-tacky surface on a second side. The extruded material may be extruded onto the second side of the adhesive material and around the first end of the twist tie. The method may include molding an object in the mold from the extruded material. The second side of the adhesive material and the first end of the twist tie may be molded to the object.

### CROSS-REFERENCES TO RELATED APPLICATIONS

This application is a divisional application of U.S. application Ser. No. 14/759,388 filed Jul. 6, 2015, which is a National Stage of PCT Application No. PCT/US2014/010334 filed on Jan. 6, 2014, which PCT application claims the benefit of US Provisional Application No. 61/749,810 filed Jan. 7, 2013. All of the above applications are hereby incorporated by reference to the same extent as though fully contained herein.

### BACKGROUND

There are a variety of items where an adhesive strip is applied to an object in order to affix the object to a surface, such as a wall or other surface. This is a labor-intensive process, since either the user of an item or a factory worker must remove a piece of adhesive strip, and many times a covering on the adhesive surface, and stick it to the item. The user or worker likely will contaminate the adhesive with oils or dirt from their hands resulting in the adhesive strip losing its adhesiveness.

### SUMMARY

In one embodiment, a method for joining adhesive tape to an object includes providing a piece of adhesive material, the piece of adhesive material having an adhesive surface covered with a removable cover on a first side and a non-tacky surface on a second side. The method further includes placing the piece of adhesive material in a mold and extruding an extrudable material over the adhesive tape, the extrudable material contacting the non-tacky surface of the adhesive material in the mold. The method further includes molding an object in the mold from the extrudable material and bonding the non-tacky surface to the object, the bonding resulting from the heat of the extrudable material. Optionally, the non-tacky material includes a heat-activated adhesive. In one configuration, the non-tacky material is a material that is compatible with the extrudable material for bonding purposes. In one alternative, the non-tacky material is polypropylene, and the extrudable material is thermoplastic elastomers (TPE). Optionally, the adhesive material includes a piece of adhesive tape, the adhesive tape having adhesive on both sides of the tape, a first side of the adhesive tape sticking to the polypropylene and a second side of the adhesive tape having the adhesive surface covered with the removable cover.

In one embodiment, an article includes a body, the body formed of an extruded material. The article further includes a piece of adhesive material, the piece of adhesive material having an adhesive surface covered with a removable cover on a first side and a second side bonded to the body, wherein the bonding results from heat contained in the extruded material during the bonding process. Optionally, the second side includes a non-tacky heat-activated adhesive. In one alternative, the second side includes a non-tacky material, the non-tacky material is a material that is compatible with the extruded material for bonding purposes, and the non-tacky material bonds to the extruded material when heated. In another alternative, the non-tacky material is polypropylene and the extruded material is TPE. Optionally, the extruded material is TPE.

In one embodiment, an article for hanging objects includes a twist tie and a body, the body connected to the twist tie. The article further includes a piece of adhesive material, the piece of adhesive material having an adhesive surface covered with a removable cover on a first side and a second side bonded to the body, wherein the bonding results from heat contained in the extruded material during the bonding process. Optionally, the second side includes a non-tacky heat-activated adhesive. Alternatively, the second side includes a non-tacky material, and the non-tacky material is a material that is compatible with the extruded material for bonding purposes, and the non-tacky material bonds to the extruded material when heated. Optionally, the non-tacky material is polypropylene and the extruded material is TPE. Alternatively, the extruded material is TPE. Optionally, the article is formed by placing a twist tie and the piece of adhesive material in a mold and extruding the body around a first end of the twist tie and on top of the second side of the adhesive material.

In another embodiment, a method of making an article for hanging objects includes placing a first end of a twist tie in a mold. The method further includes placing a piece of adhesive material in the mold, the adhesive material having an adhesive surface covered with a removable cover on a first side and a second side of non-tacky material, the second side facing up. The method further includes extruding an extruded material onto the second side and around the first end of the twist tie, with heat from the extruding forming a bond between the second side and the extruded material. Optionally, the second side includes a non-tacky heat-activated adhesive. In one alternative, the second side includes a non-tacky material, and the non-tacky material is a material that is compatible with the extruded material for bonding purposes, and the non-tacky material bonds to the extruded material when heated. Optionally, the non-tacky material is polypropylene and the extruded material is TPE. In one configuration, the extruded material is TPE.

In another embodiment, an article for hanging objects includes a twist tie and a body, the body connected to the twist tie. The article further includes a piece of adhesive material, the piece of adhesive material having an adhesive surface covered with a removable cover on a first side and a second side bonded to the body. Optionally, the bonding results from heat contained in the extruded material during the bonding process. Optionally, the durometer of an outer layer of the twist tie is less than 50 shore A.

### BRIEF DESCRIPTION OF THE DRAWINGS

FIG. 1 shows one embodiment of a twist tie hanger;

FIG. 2 shows a rear view of the twist tie hanger of FIG. 1;

FIG. 3 shows a front side view of the twist tie hanger of FIG. 1;

FIG. 4 shows a left side view of the twist tie hanger of FIG. 1;

FIG. 5a shows an embodiment of a mold for use in making the twist tie hanger of FIG. 1; and

FIG. 5b shows the mold of FIG. 5a with an adhesive strip and twist tie inserted.

### DETAILED DESCRIPTION OF THE DRAWINGS

Various systems and methods for creating objects including adhesive strips are included herein. In many embodiments, creation of items according to the methods herein occurs according to two paradigms. A first technique includes creating an unique item having a non-tacky surface that is bonded to a thermoplastic or thermoset material. The non-tacky surface generally includes a heat active adhesive which is activated when the thermoplastic or thermoset material is extruded onto the non-tacky surface. Essentially, this might be terms a method of activating a non-tacky surface by extruding a thermoplastic or thermoset material on to it. In an alternative, a molecularly compatible thermoplastic or thermoset film is used to create a molecular bond with a thermoplastic or thermoset polymer in order to create a unique item. Essentially, this method includes activating thermoplastic or thermoset material for bonding by extruding a thermoplastic or thermoset onto it. In many of the embodiments described herein, the objective is to attach a pressure sensitive adhesive via either of the above two paradigms.

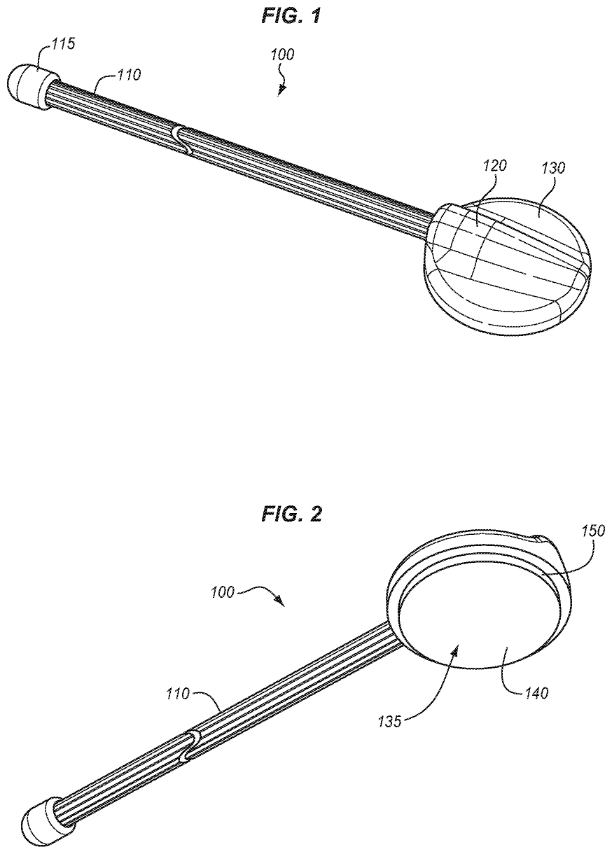

FIG. 1 shows a gear tie hanger (GTH) 100. GTH 100 includes a twist tie 110, including an end cap 115. The twist tie 110 is molded into body 130, which includes protrusion 120 that surrounds the molded twist tie 110. Preferably, twist tie 110 is a Gear Tie™ brand twist tie which has superior gripping and durability characteristics. The ability to affix a gear tie to a surface provides great flexibility to the user in terms of what may be hung from GTH 100. Many times, objects may not hang cleanly and securely from a hook. The provision of twist tie 110 allows for a wide variety of objects to be hung from GTH 100, not merely those that may be hung from a hook. The properties of twist tie 110 include a softer durometer outer layer for the twist tie 110 (for example less than 50 shore A). This allows the twist tie 110 to deform slightly when wrapped around an object, allowing it to hold objects that are smooth and do not possess a lip or other feature to wrap around a hook. Therefore, the GTH 100 provides superior holding capability.

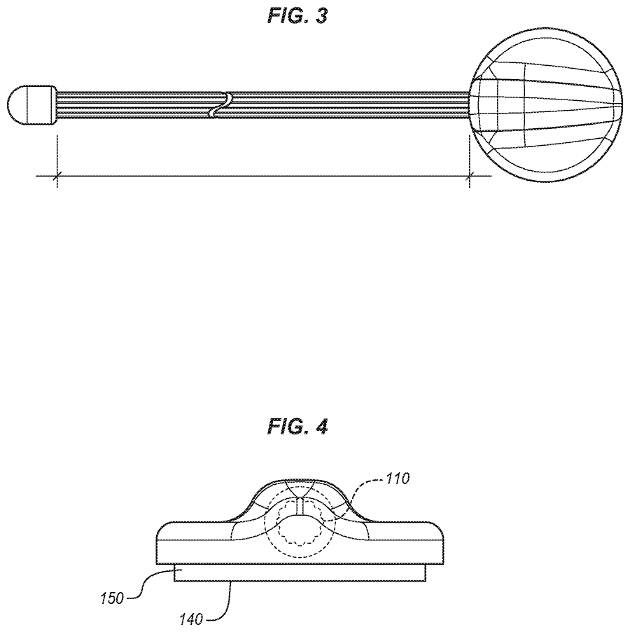

FIG. 2 shows the opposite side of GTH 100. On the underneath side of the GTH 100 is an adhesive strip 135 including foam buffer and peel off adhesive cover 140. This strip is not merely attached to the GTH 100, but instead, as will be described in further detail below, is chemically adhered as a result of the activation of a heat-activated adhesive during the extrusion process. FIGS. 3 and 4 show additional views of the GTH 100. In FIG. 4, the location of the twist tie within the body 130 is visible.

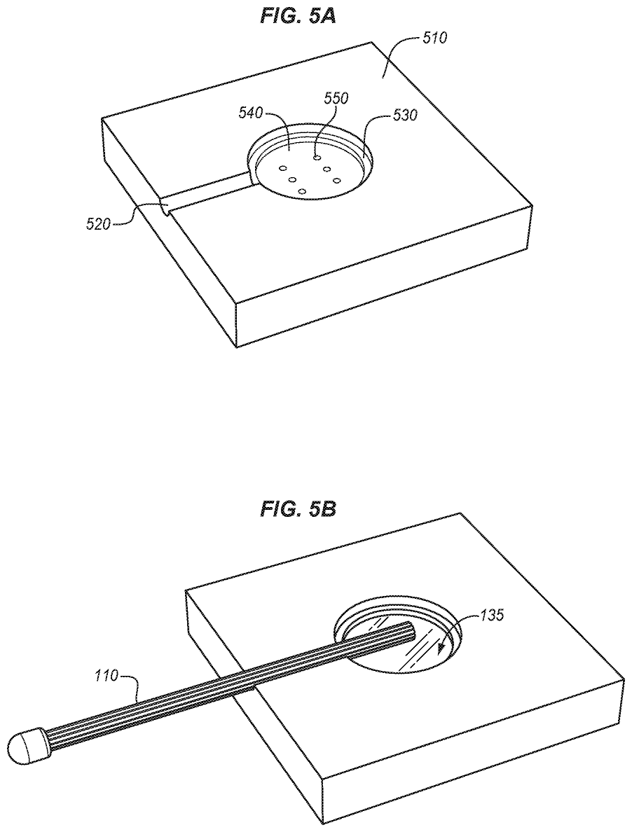

FIG. 5a shows one-half of a mold for use in making a GTH 100. The mold 510 includes a first depression 520 for receiving and aligning the twist tie 110. The twist tie end placed in the mold should not have a cap 115. Depression 530 provides the shape of the body 130 of the GTH 100. The deeper depression 540 is shaped to receive adhesive strip 135 and is the proper depth so that, when adhesive strip 135 is inserted, it will be flush with the bottom of depression 530. The apertures 550 shown are optional and may not be included in all designs. These apertures 550 provide for vacuum pressure to hold adhesive strip 135 in place during molding. If the deeper depression that adhesive strip 135 sits in has a bend in it, or any odd angles, this will retain adhesive strip 135 firmly against the mold during the extrusion process. In this way, the adhesive strip 135 can be bonded in unique configurations including, but not limited to, fitting in a positive or negative corner.

FIG. 5b shows the mold with the twist tie 110 and the adhesive strip 135 in place.

The structure achieved by the described process results in a superior bond of the adhesive strip to the extruded material. The preferred materials are important to consider. The body and the twist tie typically are composed of thermoplastic elastomer. It is very difficult in many cases for adhesive to stick to such materials. In this case, the adhesive strip is 3M™ W4112 adhesive tape. Other 3M™ tapes includes 3M™ Weatherstrip attachment tape 5403 (also 4981, 5935, 5404, ST1200, and WT4112). Some of these adhesive tapes such as WT4112 and ST1200 include a layer of foam between the pressure sensitive adhesive and the heat activated adhesive. The 4981 tape includes a polyester film between adhesives instead. This includes heat-activated E2 adhesive. This adhesive tape has a heat-activated adhesive on one side and a pressure sensitive adhesive covered by a protective strip on the other side.

The distinctive structural characteristics imparted to the product produced by using this adhesive tape and molding on top of it is multifold as compared to an adhesive strip having two sides of contact adhesive. First, the alignment of the adhesive strip is superior, since the adhesive strip sits in a depression that is correctly oriented during extrusion. Second, the bond is superior, due to the heat-based molecular bonding. The bond is also superior, since some contamination of a contact adhesive usually occurs during application. This does not occur with the heat-activated adhesive, since prior to heat activation the surface is not tacky. Therefore, contamination is much less likely. Also, as described above, using vacuum pressure to hold the adhesive tape in place, various three-dimensional configurations of the tape may be created, such as holding the tape on a corner so that it folds and after extrusion holds the shape of the corner. Moreover, the adhesion provided by the heat-activated adhesive is stronger and much less likely to release. Therefore, when the GTH 100 is placed and then later removed, a portion of the adhesive strip is much less likely to release from the GTH 100. Therefore, the only release point is the pressure sensitive adhesive on the other side, which generally results in a clean removal of the GTH 100 and a much reduced chance of piece of the adhesive strip being left behind.

In an alternative, instead of using an adhesive strip composed of 3M™ W412 adhesive tape, a piece of polypropylene is substituted. Polypropylene or other material may have superior bonding to the TPE material used as compared to a pressure sensitive adhesive. Alternatively, instead of TPE, other thermoset and thermoplastic polymers may be used, including but not limited to: rubber or ethylene propylene rubber (EPM) may be used in place of TPE. These materials also have very poor bonding characteristics; however, they will bond well to polypropylene, which is a good material on which a pressure sensitive adhesive may be placed.

Although GTH 100 is shown as resulting from the bonding process used during heat extrusion, a variety of products may be formed according to the same procedure. In other words, instead of the body and twist tie shown, almost any product may be extruded onto the heat-activated adhesive in order to attach an adhesive strip to the product. These products may include traditional hooks as are commonly used with adhesive strips or other products made of rubber, such as moldings, etc. A wide variety of products composed of thermoset and thermoplastic polymers, including but not limited to TPE, EPM, or rubber, may be created and attached to adhesive strips as described herein. Alternatively, as described herein, a superior surface for attaching adhesive to extruded materials may be created as described herein. This material may be polypropylene or other materials that bond to thermoset and thermoplastic polymers, including but not limited to TPE, EPM, or rubber under the heat and pressure created during the molding process. In addition to bonding polypropylene to thermoset and thermoplastic polymers, cross-link polyethylene foams may be used as a bonding layer, since cross-link polyethylene foams have compatible bonding characteristics with thermoset and thermoplastic polymers such as TPE. Furthermore, alloyed TPE, which is formulated to bond with acrylic films, could be used with or without a Plexar™ bonding agent to bond to metal or a magnet.

The previous detailed description is of a small number of embodiments for implementing the systems and methods for creating objects with bonded adhesive strips and the systems of the objects with bonded adhesive strips and is not intended to be limiting in scope. The following claims set forth a number of the embodiments of the systems and methods for creating objects with bonded adhesive strips and the systems of the objects with bonded adhesive strips disclosed with greater particularity.

What is claimed is:

1. A method comprising:
placing an adhesive material in a mold, the adhesive material comprising an adhesive surface covered with a removable cover on a first side and a non-tacky surface on a second side;
extruding an extrudable material in the mold, the extrudable material contacting the non-tacky surface of the adhesive material in the mold;
molding an object in the mold from the extrudable material; and
bonding the non-tacky surface to the object, the bonding resulting from the heat of the extrudable material.

2. The method of claim 1, wherein the non-tacky surface comprises a heat-activated adhesive.

3. The method of claim 1, wherein the non-tacky surface comprises a non-tacky material that is compatible with the extrudable material for bonding purposes.

4. The method of claim 3, wherein the non-tacky material is polypropylene and the extrudable material is a thermoplastic elastomer.

5. The method of claim 4, wherein the adhesive material comprises a piece of adhesive tape with a first side and a second side, the first side comprising non-tacky polypropylene, the second side comprising the adhesive surface covered with the removable cover.

6. The method of claim 1, further comprising placing a first end of a twist tie in the mold, wherein extruding the extrudable material in the mold bonds the first end of the twist tie to the object.

7. The method of claim 6, wherein the twist tie comprises an opposing second end defining a free end of the twist tie.

8. The method of claim 7, wherein the adhesive material and the twist tie create a cooperative holding mechanism for hanging an article from the free end of the twist tie, with the object adhesively attachable to a surface via the adhesive material and the free end of the twist tie twistable around the article to hang the article from the surface.

9. A method comprising:
placing a first end of a twist tie in a mold;
placing a piece of adhesive material in the mold, the piece of adhesive material comprising an adhesive surface covered with a removable cover on a first side and a non-tacky surface on a second side; and
extruding a material into the mold, onto the second side of the piece of adhesive material and around the first end of the twist tie, to bond the extruded material, the second side of the piece of adhesive material, and the first end of the twist tie together.

10. The method of claim 9, wherein the non-tacky surface comprises a non-tacky heat-activated adhesive.

11. The method of claim 9, wherein the non-tacky surface comprises a non-tacky material that bonds to the extruded material when heated.

12. The method of claim 11, wherein the non-tacky material is polypropylene and the extruded material is a thermoplastic elastomer.

13. The method of claim 9, wherein extruding the material into the mold comprises molding an object in the mold from the extruded material, the second side of the piece of adhesive material and the first end of the twist tie molded to the object.

14. The method of claim 13, wherein the piece of adhesive material and the twist tie create a cooperative holding mechanism for hanging an article from a free end of the twist tie, with the object adhesively attachable to a surface via the adhesive material and the free end of the twist tie twistable around the article to hang the article from the surface.

15. The method of claim 9, wherein the mold comprises a first depression for receiving and aligning the twist tie.

16. The method of claim 15, wherein the mold comprises a second depression for receiving the piece of adhesive material.
